(19) United States
(12) Patent Application Publication
(10) Pub. No.: US 2009/0053085 A1
(43) Pub. Date: Feb. 26, 2009

(54) Peristalitic pump assembly and method for attaching a cassette thereto

(76) Inventors: Loren M. Thompson, Lapeer, MI (US); Robert R. Voltenburg, JR., Davison, MI (US)

Correspondence Address: DELPHI TECHNOLOGIES, INC., M/C 480-410-202, PO BOX 5052, TROY, MI, 48007, US

(21) Appl. No.: 11/895,434

(22) Filed: Aug. 24, 2007

(51) Int. Cl. F04B 43/12; B23P 15/00

(52) U.S. Cl. 417/477.2; 29/888.022

(57) ABSTRACT

A peristaltic pump assembly includes a housing having a cassette receiving portion defined therein, a securing shaft positioned within the cassette receiving portion, and a cassette including a tube disposed therein selectively engageable with the cassette receiving portion. A knob removably engages a portion of the securing shaft and includes a tab extending therefrom configured to contact and compress the tube when in a disengagement position.

### BACKGROUND

The present disclosure relates generally to peristaltic pumps, and more particularly, to a peristaltic pump assembly and a method for attaching a cassette thereto.

Rotary-style peristaltic infusion pumps often include a cassette supported by a pump housing, and an assembly of radially arranged rollers. The rollers revolve together when rotationally driven by a drive shaft operated by a pump motor. A flexible tube is disposed around a portion of the assembly of rollers, and, in response to rotational movement of the rollers, portions of the flexible tube that are in contact with the rollers compress or are otherwise occluded against a wall of the cassette. As a result, fluid is temporarily retained in the tube between the occluded points. In this manner, fluid is urged through the tube via peristaltic wave action.

Peristaltic infusion pumps are often used to deliver fluid in a controlled manner, for example, in conjunction with the intravenous delivery of fluids and/or pharmaceutical compositions to a patient. These peristaltic pumps typically use disposable cassettes, where the pump assembly is designed to accommodate the loading of the cassette, as well as the removal of the cassette from the assembly. Such designs may undesirably involve relatively difficult cassette loading and removal schemes.

### SUMMARY

An embodiment of the peristaltic pump assembly disclosed herein includes a housing having a cassette receiving portion defined therein. A securing shaft is positioned within the cassette receiving portion of the housing. A cassette is selectively receivable with the cassette receiving portion. A tube is operatively connected to the cassette. A knob is removably engageable with the securing shaft, and the knob includes a tab extending therefrom configured to contact and compress the tube when in a disengagement position.

Also disclosed herein is a method of removably attaching a cassette to a peristaltic pump assembly. The method includes placing a cassette including a tube disposed therein in a cassette receiving portion of a housing. The cassette receiving portion includes a securing shaft having a first engagement member. The method further includes placing a knob on the cassette so that the knob is in a disengagement position. The knob has a tab extending therefrom configured to contact and compress the tube when in the disengagement position. The knob is also placed on the cassette so that the second engagement member aligns with the first engagement member. The knob is rotated to an engagement position. When in the engagement position, the tab is removed from contact with and decompresses the tube, and the first engagement member engages with the second engagement member, thereby locking the cassette to the housing.

### BRIEF DESCRIPTION OF THE DRAWINGS

Features and advantages of embodiment(s) of the present disclosure will become apparent by reference to the following detailed description and drawings, in which like reference numerals correspond to similar, though perhaps not identical components. Reference numerals having a previously described function may or may not be described in connection with other drawings in which they appear.

FIG. 1 is a perspective view of an example of a rotary-style peristaltic infusion pump assembly;

FIG. 2 is a perspective, cutaway view of an example of a housing for the peristaltic pump assembly with the rollers not shown;

FIG. 3 is an enlarged, perspective view of an example of a drive shaft including a securing shaft disposed therethrough;

FIG. 4 is a top view of an example of a cassette shown engaging a roller assembly (in phantom);

FIG. 5 is a top, perspective view of an example of a knob for the peristaltic pump assembly;

FIG. 6 is a bottom, perspective view of the knob of FIG. 5;

FIG. 7 is an exploded, perspective, cutaway semi-schematic view of the cassette and the housing of FIG. 1;

FIG. 8 is an exploded, perspective view of the knob and the cassette, depicting the knob in a disengagement position; and

FIG. 9 is an exploded, perspective view of the knob and the cassette, depicting the knob in an engagement position.

### DETAILED DESCRIPTION

Embodiment(s) of the peristaltic pump assembly and the method of attaching a cassette to the peristaltic pump assembly as disclosed herein advantageously provide a simplified pump assembly design to facilitate easier loading and removal of the cassette to and from the pump assembly. The cassette further includes a mechanism to occlude the tube prior to loading the cassette, such that a free flow of fluid passing through the tube is substantially prevented before such flow is desirable. The pump housing may also be advantageously designed to seal the cassette, thereby protecting rotating parts (e.g., the rollers) from fluid, debris (such as dust), or other foreign particulates present in the environment. It is believed that the design of the pump assembly furthermore facilitates easier maintenance thereof.

Without being bound to any theory, it is believed that at least some of these advantages are a result of tubing occlusion in the z-axis, which has not heretofore been used on rotary peristaltic pumps, to the inventors' knowledge. Further, embodiment(s) of the present disclosure have advantageously combined a cassette attachment mechanism and a tubing occlusion member into one piece (i.e., the knob, as discussed further below).

As defined herein, the “disengagement position” indicates the position of a knob when a cassette is not attached to a housing. An “engagement position” indicates the position of the knob when the cassette is attached to the housing. It is to be understood that the engagement position and the disengagement position are spaced apart by any desired angle, non-limiting examples of which include 45°, 90°, 135°, or any angles therebetween. In an embodiment, the engagement position and the disengagement position are equal to or less than about 90° apart from each other.

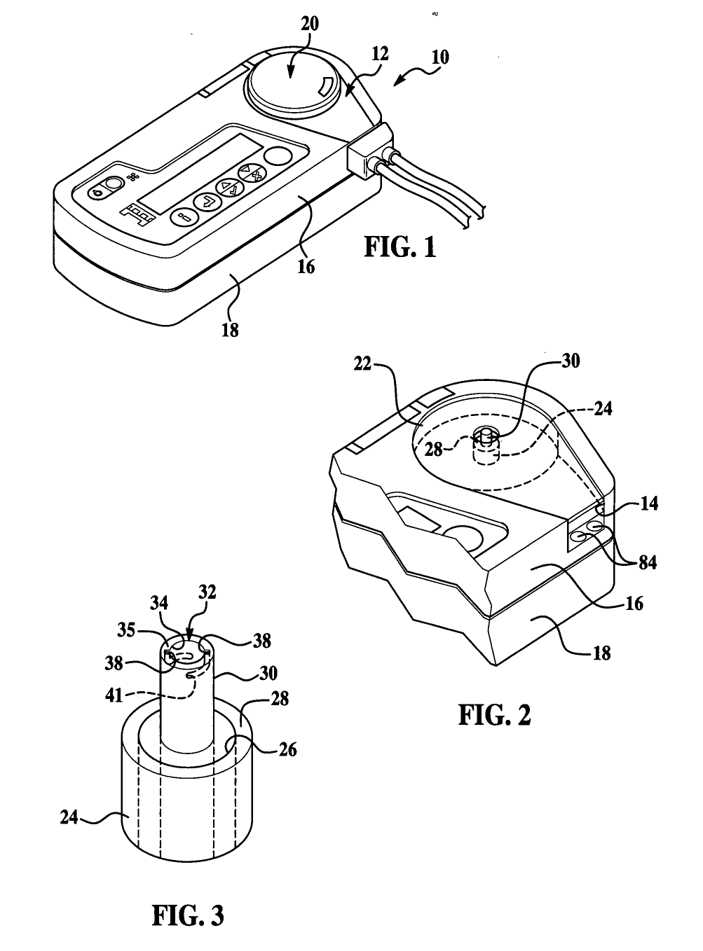

Referring now to FIGS. 1 and 2 together, a rotary-style peristaltic infusion pump assembly is designated generally as 10. Pump assembly 10 includes a disposable pump cassette 12 supported or selectively receivable within a cassette receiving portion 14 defined within a housing 16. A knob 20, which is removably engageable with a securing shaft 30 positioned within the cassette receiving portion 14, is disposed over the cassette 12 and attached to the housing 16, thereby securing the cassette 12 to the housing 16. The pump assembly 10 also includes a pump motor 18 disposed within, below, or otherwise adjacent to the housing 16; and the pump assembly 10 is operatively connected to the pump motor 18 via e.g., a drive shaft 24.

As shown in FIG. 2, the cassette receiving portion 14 is generally provided as a cavity that is formed into, or otherwise defined within the housing 16. As depicted, the portion 14 is generally configured complementarily to the shape of the cassette 12 that is placed therein. A thin membrane 22 (shown in FIG. 2) may be positioned adjacent the top of the cassette receiving portion 14 and covers the pump rollers 48 (not shown in FIG. 2, but discussed further below). The membrane 22 forms a barrier inside the cassette receiving portion 14 between the housing 16 and the cassette 12. The barrier provides suitable protection from fluid, debris and/or other foreign particulates in the environment for pumping mechanism(s). The barrier/membrane 22 also permits relatively simple maintenance and cleaning of the cassette receiving portion 14. It is to be understood that the membrane 22 may be made of any suitable material. In an embodiment, membrane 22 is formed from a polyester film. An example of a suitable polyester film is commercially available under the Mylar® trade designation from DuPont Teijin Films in Hopewell, Va. MYLAR polyester film is a biaxially oriented, thermoplastic film made from ethylene glycol and dimethyl terephthalate (DMT).

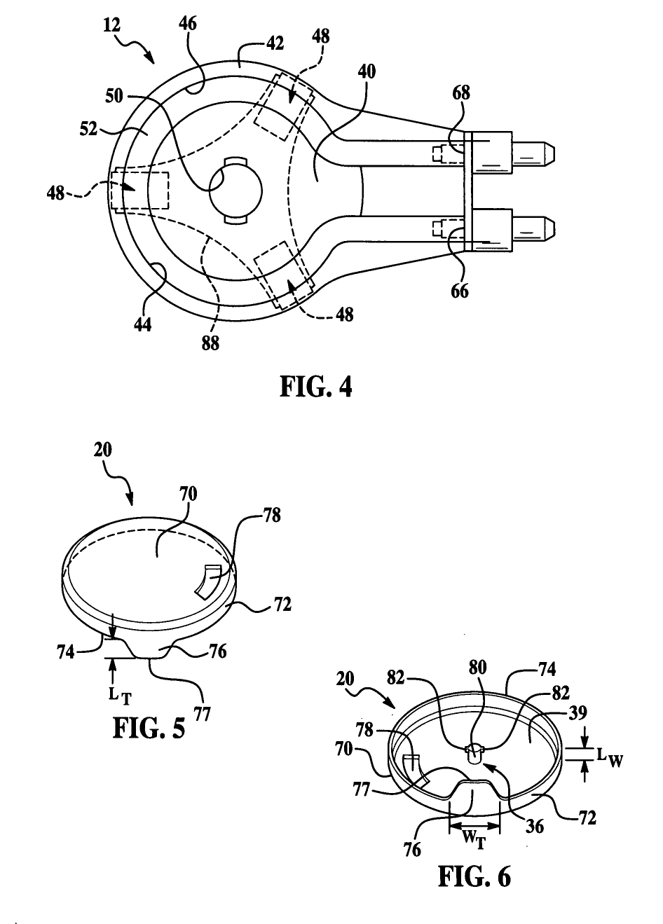

Referring now additionally to FIG. 3, the drive shaft 24 may be generally cylindrically shaped and is disposed through a bore (not shown) formed in the cassette receiving portion 14. The drive shaft 24 includes a bore 26 extending through the shaft 24 in an axial direction. The drive shaft 24 engages rollers 48 (shown in FIG. 4) of a rotary assembly inside the housing 16 to thereby drive the rollers 48 in a planetary motion.

The securing shaft 30 is disposed through the bore 26 formed in the drive shaft 24 and protrudes substantially above the edge or surface 28 for selective and removable engagement with the knob 20. A suitable amount of clearance is provided between the drive shaft 24 and the securing shaft 30 to thereby allowing the drive shaft 24 to rotate without interfering with the securing shaft 30.

As shown in FIG. 3, the securing shaft 30 is generally cylindrically-shaped and includes an engagement member 32 formed therein. In an embodiment, the engagement member 32 includes a bore 34 formed into a top surface 35 of the shaft 30 and is shaped to mate with a second engagement member 36 formed on a bottom surface 39 of the knob 20 (shown in FIG. 6). In an embodiment, the bore 34 has the female portion 38 of a bayonet fitting established therein.

The plan view of the disposable cassette 12 for use in the pump assembly 10 of the present disclosure is provided in FIG. 4. The cassette 12 includes a base 40 and a wall 42 (having an inner surface 44) which define a generally cylindrically-shaped cavity 46. The cassette 12 may be made from a suitably rigid polymeric material, examples of which include acrylonitrile butadiene styrene (ABS), polycarbonate, glass filled polymeric materials, or the like, or combinations thereof. Further, it is to be understood that the cassette 12 may be made by any suitable process, an example of which includes injection molding.

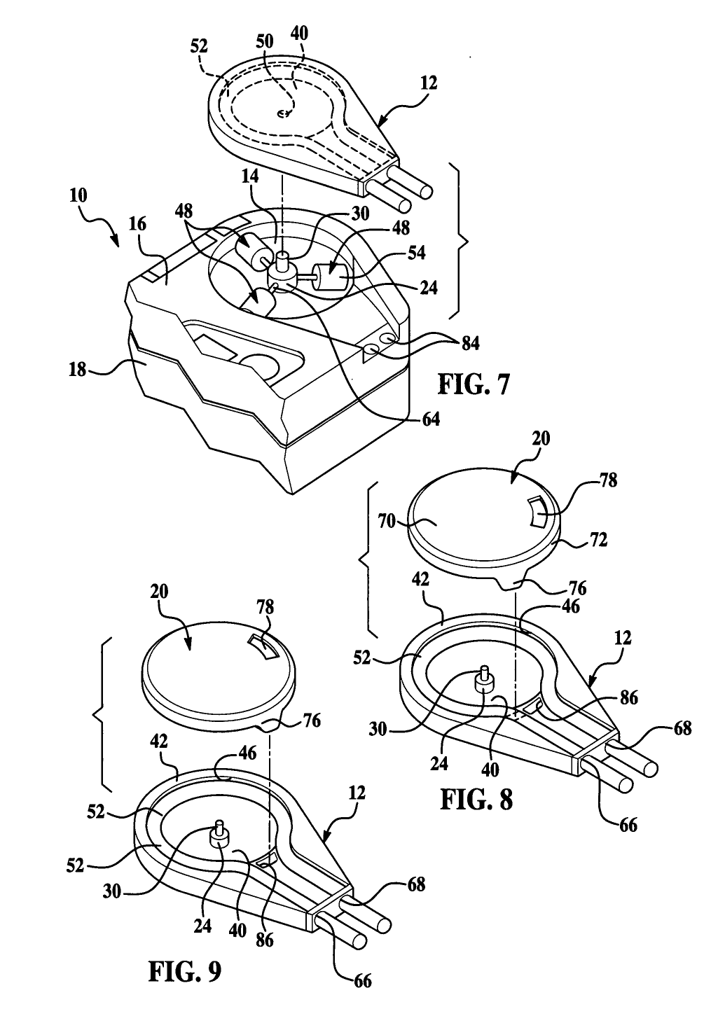

An assembly of satellite rollers 48, when the cassette 12 is engaged with the housing 16, is received within the cavity 46 of the cassette 12 and radially arranged around a bore 50 formed in the cassette 12. Each roller 48 is located adjacent to and abuts (in the z-axis) a substantial portion of a tube 52 disposed within the cassette 12 (discussed hereinbelow). Each roller 48 includes a generally cylindrically-shaped body 54. It is to be understood that each roller 48 may be supported by any suitable means; e.g., on a shaft 64 attached to drive shaft 24 in the pump housing 16 (see FIG. 7), or with a yoke 88 (see FIG. 4). The individual shafts 64/yoke 88 define a general axis of rotation for the respective rollers 48, so that each roller 48 may rotate relatively freely about its shaft 64/yoke 88. It is to be understood that movement of the rollers 48 in a planetary rotation is guided by the drive shaft 24.

The previously mentioned flexible or otherwise compressible tube 52 is disposed through an inlet 66 of the cassette 12, around a substantial portion of the inner surface 44 of the wall 42, and through an outlet 68, and is operatively connected to the cassette 12. When the cassette 12 is engaged with the pump housing 16, the rollers 48 occlude tube 52 in the z-axis (as seen in FIGS. 4 and 7).

In an embodiment, the tube 52 is disposable, and is made of a polymeric material, non-limiting examples of which include silicones, AUTOPRENE (an opaque thermoplastic rubber with high wear resistance derived from SANTOPRENE, commercially available from Advanced Elastomer Systems, a subsidiary of ExxonMobil Chemical located in Houston, Tex.), VITON (a black fluoroelastomer with resistance to concentrated acids, solvents, ozone, radiation and temperatures up to 200° C. with good chemical compatibility, commercially available from DuPont Performance Elastomers located in Wilmington, Del.), TYGON (good chemical resistance with a clear finish, commercially available from Saint-Gobain Performance Plastics Corporation located in Akron, Ohio), PROTHANE II (a transparent, blue, polyester, polyurethane tubing with good chemical resistance, commercially available from Randolph Austin Company located in Manchaca, Tex.), and/or the like, and/or combinations thereof. The inner diameter of the tube 52 may be selected based on the desirable flow rates and the desirable viscosities of the fluid that will flow therethrough.

When the cassette 12 is placed within the cassette receiving portion 14 of the housing 16, the rollers 48 within the pump housing 16 generally contact/occlude tube 52 in the z-axis. Upon rotation of the drive shaft 24, the roller assembly (i.e., the rollers 48 operating as a single unit) rotates. The rotational movement of the rollers 48, both individually and as an assembly, pumps the fluid through the tube 52 to create a pressurized flow thereof. The tube 52 compresses or otherwise occludes at a number of points in contact with the rollers 48 when the roller assembly and the individual rollers 48 are rotating. The fluid is temporarily trapped in the tube 52 between two points of occlusion (e.g., at one roller 48 and at an adjacent roller 48). In this manner, fluid is urged through the tube 52 via peristaltic wave action at a flow rate proportional to the rotational rate (rpm) of the drive shaft 24.

The knob 20 is generally depicted in FIGS. 5 and 6. The knob 20 includes a top portion 70 having a relatively flat surface that is attached to, or formed integrally with a generally cylindrically-shaped wall 72. The wall 72 extends from and is disposed about the periphery of the top portion 70. An edge of the wall 72 that is opposed to the top surface 70 forms a bottom edge 74 of the knob 20. In an example, the wall 72 has a length L_{W} that is approximately equal to the diameter of the tube 52 used in the cassette 12. However, it is to be understood that the wall 72 length L_{W} is not necessarily related to the tube 52 diameter. The knob 20 generally has a hollow portion defined by top portion 70 and the wall 72.

In an embodiment, the wall 72 includes a tab 76 such as, for example, a ramp. It is to be understood that the knob 20 is moveable between the engagement and the disengagement positions. The tab 76 is configured to contact and compress the tube 52 (e.g., at or about the area on tube 52 designated by dashed lines under the exploded view line of FIG. 8) when the knob 20 is in the disengagement position. Compression is achieved by the tab 76 without substantially damaging or puncturing the tube 52. When the knob 20 is in the engagement position, the tab 76 is positioned so as to decompress the tube 52, thereby allowing fluid flow through the tube 52. Cassette 12 may include a slot 86 complementarily shaped with tab 76, and adapted to receive tab 76 when knob 20 is in the engagement position. In an embodiment, the width W_{T} of the tab 76 ranges from about 10 mm to about 15 mm, and the length L_{T} of the tab 76 from a bottom edge 74 of the wall 72 to the contact point or edge 77 ranges from about 3 mm to about 5 mm.

In an embodiment, the tab 76, including the contact point or surface 77, is generally blunt and approaches the length L_{T} gradually. The tab 76 is located on or otherwise protrudes from the bottom edge 74 of the wall 72 and extends in a direction substantially normal to the top portion 70.

The knob 20 is generally made from a polymeric material, examples of which include acrylonitrile butadiene styrene (ABS), polycarbonate, glass filled polymeric materials, or the like, or combinations thereof. Also, the knob 20 may be fabricated as a single piece using any suitable fabrication method such as, for example, injection molding.

A window 78 may be formed into the top portion 70 of the knob 20. Window 78 may be positioned about 90° or less (e.g., in a counter-clockwise direction) from the tab 76, in a manner sufficient to indicate a position of the tab 76. In an embodiment, the window 78 may have a color scheme, wherein a first color would indicate a first position or status of the cassette 12, and a second color would indicate a second position or status of the cassette 12. As a non-limiting example, if the tab 76 engages the tube 52, the window 78 may have a color, such as red, to indicate that no fluid flow is present. If the tab 76 disengages the tube 52, the window may have a different color, such as green, to indicate that fluid flow is present.

As shown in FIG. 6, the second engagement member 36 is located on the bottom surface 39 of the top portion 70 of the knob 20 and is configured to removably engage the opposing first engagement member 32 of the securing shaft 30 when the knob 20 is rotated into the engagement position. The second engagement member 36 includes a shaft 80 having an outer diameter that coincides with the diameter of the bore 34 of the first engagement member 32. In an embodiment, the shaft 80 has a male portion 82 of a bayonet fitting established thereon.

Pump assembly 10 may include any suitable sensors, as desired. In an example, two sensors 84 may be included (as shown in FIGS. 2 and 7). The sensor 84 on the input side near inlet 66 may be a pressure sensor to sense upstream tubing occlusions. Typical pressure sensors are strain gauge or piezo resistive. The sensor 84 on the output side near outlet 68 may be a combination sensor for air-in-line and pressure. The pressure sensor senses downstream tubing occlusions and may be strain gauge or piezo resistive, as above. The air-in-line sensor senses air bubbles in the tubing. Typical air-in-line sensors are ultrasonic or optical. If desired, all of the sensors 84 may be configured to cause the pump assembly 10 to shut down and emit an alarm(s) when preset limits for pressure and air-in-line limits are exceeded (low or high).

With reference now to FIGS. 7-9, the cassette 12 may be removably attached to the pump assembly 10 in the following manner. As provided hereinabove, the knob 20 is referred to as movable or rotatable between disengagement and engagement positions, wherein the angle between the disengagement and engagement positions may be any desirable angle, for example, equal to or less than about 90°. In one example, from the disengagement position, the knob 20 may be rotated about 90° or less (i.e., about a quarter turn) counter-clockwise to be placed in the engagement position. Likewise, from the engagement position, the knob 20 may be rotated about 90° or less clockwise to be placed in the disengagement position.

As shown in FIG. 7, the cassette 12 is loaded into the pump housing 16 by placing the cassette 12, including the tube 52 disposed therein, in the cassette receiving portion 14 of the housing 16. When the cassette 12 is placed therein, the drive shaft 24 including the securing shaft 30 disposed therethrough is disposed through the bore 50 formed in the base 40 of the cassette 12. The drive shaft 24 having the rollers 48 operatively attached thereto causes operative rotational movement of the rollers 48 when powered by the pump motor 18.

With reference now to FIG. 8 (and also with reference to FIGS. 3 and 6), the knob 20, now in the disengagement position, is placed on the cassette 12 by aligning the shaft 80 and the second engagement member 36 with the bore 34 and the first engagement member 32, respectively. An applied force on the knob 20 downwardly against the cassette 12 forces the wall portion 72 of the knob 20 into the cavity 46 such that the tab 76 engages the tube 52. When in this position, the tube 52 is completely compressed or occluded, thereby preventing any fluid flow therethrough. In an alternate example, the knob 20 and the cassette 12 may be a two piece assembly and pre-assembled (e.g., utilizing a radial snap feature) before being received by the user.

The knob 20 is then rotated into the engagement position by applying a rotational force thereto. In an embodiment, the knob 20 is rotated about a quarter turn (less than or equal to 90°) in a counter-clockwise direction to allow the second engagement member 36 to engage with the first engagement member 32 (e.g., male portion 82 of the bayonet fitting matingly engages with the female portion 38 of the bayonet fitting), thereby engaging the securing shaft 30 and locking the cassette 12 to the housing 16. The knob 20 is now in the engagement position, as shown in FIG. 9. As the knob 20 is turned, the tab 76 also rotates counter-clockwise and releases the tube 52, thereby allowing fluid flow therethrough.

The cassette 12 is unlocked from the housing 16 by rotating the knob 20 from the engagement position to the disengagement position (i.e., about a quarter turn in a clockwise direction). The tab 76 then contacts and compresses the tube 52, and the second engagement member 36 disengages from the first engagement member 32.

It is to be understood that the term “connect/connected/connecting” is broadly defined herein to encompass a variety of divergent connection arrangements and assembly techniques. These arrangements and techniques include, but are not limited to (1) the direct connection between one component and another component with no intervening components therebetween; and (2) the connection of one component and another component with one or more components therebetween, provided that the one component being “connected to” the other component is somehow operatively connected to the other component (notwithstanding the presence of one or more additional components therebetween).

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. A peristaltic pump assembly, comprising:
a housing having a cassette receiving portion defined therein;
a securing shaft positioned within the cassette receiving portion;
a cassette selectively receivable within the cassette receiving portion;
a tube operatively connected to the cassette; and
a knob removably engageable with the securing shaft, the knob having a tab extending therefrom configured to contact and compress the tube when in a disengagement position.

2. The assembly as defined in claim 1, further comprising:
a pump motor positioned within the housing, below the housing, adjacent to the housing, or a combination thereof; and
a drive shaft operatively connected to the pump motor, and operatively connected to the cassette when the knob is in an engagement position.

3. The assembly as defined in claim 2 wherein the securing shaft is disposed through the drive shaft.

4. The assembly as defined in claim 1 wherein the knob includes an engagement member configured to removably engage a complementary engagement member of the securing shaft when the knob is rotated to an engagement position, thereby locking the cassette to the housing.

5. The assembly as defined in claim 1 wherein the tab protrudes from a bottom edge of the knob.

6. The assembly as defined in claim 5 wherein the knob is moveable between the disengagement position and an engagement position.

7. The assembly as defined in claim 6 wherein when the knob is in the engagement position, the tab is positioned so as to decompress the tube, thereby allowing fluid flow through the tube.

8. The assembly as defined in claim 6 wherein when the knob is in the disengagement position, the tab is positioned to compress the tube, thereby restricting fluid flow through the tube.

9. The assembly as defined in claim 6 wherein the engagement position and the disengagement position are equal to or less than 90° apart from each other.

10. The assembly as defined in claim 1, further comprising at least one window formed in the knob, wherein the at least one window is configured to indicate a position of the tab.

11. The assembly as defined in claim 1, further comprising a membrane positioned on the cassette receiving portion.

12. A peristaltic pump assembly, comprising:
a housing having a cassette receiving portion defined therein;
a pump motor positioned within the housing;
a membrane established on the cassette receiving portion;
a cassette selectively receivable within the cassette receiving portion;
a drive shaft operatively connecting the pump motor to the cassette, the drive shaft having a securing shaft protruding therethrough, the securing shaft including a first engagement member;
a tube operatively connected to the cassette;
a knob including a second engagement member that is removably engageable with the first engagement member; and
a tab extending from the knob and configured to contact and compress the tube when in a disengagement position.

13. The assembly as defined in claim 12 wherein the second engagement member is established on an interior surface of the knob, and wherein the second engagement member is configured to removably engage with the first engagement member when the knob is in an engagement position.

14. The assembly as defined in claim 12 wherein the tab protrudes from a bottom surface of the knob.

15. The assembly as defined in claim 14 wherein when the knob is in an engagement position, the tab is positioned so as to decompress the tube, thereby allowing fluid flow through the tube, and wherein when the knob is in the disengagement position, the tab is positioned to compress the tube, thereby restricting fluid flow through the tube.

16. The assembly as defined in claim 15 wherein the engagement position and the disengagement position are equal to or less than 90° apart from each other.

17. The assembly as defined in claim 12, further comprising at least one window formed in a top surface of the knob, wherein the at least one window is configured to indicate a position of the tab.

18. A method of removably attaching a cassette to a peristaltic pump assembly, the method comprising:
placing a cassette including a tube disposed therein in a cassette receiving portion of a housing, wherein the cassette receiving portion includes a securing shaft having a first engagement member located therein, wherein the cassette includes a knob having a tab extending from the knob and configured to contact and compress the tube when in a disengagement position, wherein the knob is positioned on the cassette so that the second engagement member aligns with the first engagement member; and
rotating the knob to an engagement position, whereby the tab is removed from contact with, and decompresses the tube, and whereby the first engagement member engages with the second engagement member, thereby locking the cassette to the housing.

19. The method as defined in claim 18 wherein rotating the knob to the engagement position includes rotating the knob less than or equal to 90° in a counter-clockwise direction.

20. The method as defined in claim 18, further comprising rotating the knob from the engagement position to the disengagement position, whereby the tab contacts and compresses the tube, and whereby the second engagement member disengages from the first engagement member, thereby unlocking the cassette from the housing.
